(19) United States
(12) Patent Application Publication
(10) Pub. No.: US 2016/0179257 A1
(43) Pub. Date: Jun. 23, 2016

(54) DISPLAY APPARATUS

(71) Applicant: SAMSUNG DISPLAY CO., LTD., Yongin-si (KR)

(72) Inventors: Kiju IM, Suwon-si (KR); Min-Sung KIM, Hwaseong-si (KR); Thanh Tien NGUYEN, Seoul (KR); Eun Young LEE, Seoul (KR)

(21) Appl. No.: 14/875,907

(22) Filed: Oct. 6, 2015

(30) Foreign Application Priority Data
Dec. 22, 2014 (KR) 10-2014-0186160

(51) Int. Cl. G06F 3/041; G06F 3/0488

(52) U.S. Cl. CPC G06F 3/0412; G06F 3/04886

(57) ABSTRACT

A display apparatus includes a display panel to display an image, the display panel including a flat part and an edge part at least at one side of the flat part and bent toward a direction in which the image is displayed, and a cover member surrounding an end portion of the edge part.

### CROSS-REFERENCE TO RELATED APPLICATION

Korean Patent Application No. 10-2014-0186160, filed on Dec. 22, 2014, in the Korean Intellectual Property Office, and entitled: “Display Apparatus,” is incorporated by reference herein in its entirety.

### BACKGROUND

1. Field

The present disclosure herein relates to a display apparatus, and more particularly, to a display apparatus including a display panel bent in one direction.

2. Description of the Related Art

Various display apparatuses used for multimedia devices, e.g., televisions, mobile phones, navigators, computer monitors, and game machines, are being developed. The display apparatuses provide users with images containing predetermined information. The display apparatuses are subdivided into, on a front surface, an area in which the images are displayed and an area in which the images are not displayed. As the areas of the display apparatuses, in which the images are not displayed, are decreased, wider images can be displayed.

### SUMMARY

The present disclosure provides a display apparatus having a minimized bezel width.

The present disclosure also provides a display apparatus having a display panel with enhanced durability.

Embodiments provide a display apparatus, including a display panel to display an image, the display panel including a flat part and an edge part at least at one side of the flat part and bent toward a direction in which the image is displayed, and a cover member surrounding an end portion of the edge part. The flat part has a rectangular shape defined with four sides. The edge part may be provided to correspond to at least one of the four sides. The edge part is at least partially bent, to have a predetermined radius of curvature.

The display panel may include a first front surface on which the image is displayed, a first rear surface facing the first front surface, and a first side surface connecting the first front surface and the first rear surface.

The cover member surrounds one end portion of the edge part. The cover member includes a first portion facing the first front first surface, a second portion opposite to the first portion and facing the first rear surface, and a third portion connecting the first portion and the second portion and facing the first side surface.

The cover member may extend in an extension direction of at least one of the four sides of the flat part along one end portion of the edge part. The cover member may be formed of flexible metal, rubber, or an adhesive tape.

The display apparatus may further include a housing, a window member, and a dummy member. The housing accommodates the display panel, and includes a bottom part which faces the first rear surface of the display panel and is parallel to the flat part, and a side wall part bent from the bottom part toward the direction in which the image is displayed.

The window member may be disposed on the display panel and coupled to the housing. The window member constitutes a display surface of the display apparatus and simultaneously constitutes a front surface of the display apparatus.

The dummy member may be disposed between the display panel and the window member. The dummy member may allow a distance between the display panel and the window member to be maintained.

Embodiments also provide a display apparatus including the display panel, the cover member, and a touch sensor disposed on a front surface of the display panel and detecting a touch event of a user. The touch sensor includes a second rear surface facing the first front surface, a second front surface facing the second rear surface, and a second side surface connecting the second front surface and the second rear surface.

The cover member may include a first portion facing the second front surface, a second portion opposite the first portion and facing the first rear surface, and a third portion connecting the first portion and the second portion and facing the first side surface of the display panel and the second side surface.

### BRIEF DESCRIPTION OF THE DRAWINGS

Features will become apparent to those of ordinary skill in the art by describing in detail exemplary embodiments with reference to the attached drawings, in which:

FIG. 1 illustrates a perspective view of a display apparatus according to an embodiment;

FIG. 2 illustrates an exploded perspective view of a display apparatus according to an embodiment:

FIG. 3 illustrates a perspective view of a display panel according to an embodiment;

FIG. 4 illustrates a plan view of a display panel according to an embodiment;

FIG. 5 illustrates an equivalent circuit diagram of a pixel according to an embodiment;

FIG. 6A illustrates a cross-sectional view taken along line I-I′ of FIG. 2;

FIG. 6B illustrates an enlarged view illustrating a portion AA of FIG. 6A;

FIGS. 7A through 7C illustrate cross-sectional views of a cover member according to another embodiment; and

FIG. 8 illustrates a cross-sectional view of a display apparatus according to another embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer (or element) is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

The meaning of ‘include’ or ‘comprise’ specifies a feature, a region, a fixed number, a step, a process, an element and/or a component but does not exclude other properties, regions, fixed numbers, steps, processes, elements and/or components.

It will be understood that although the terms of first and second are used herein to describe various elements, these elements should not be limited by these terms. Terms are only used to distinguish one component from other components. For example, a first element referred to as a first element in one embodiment can be referred to as a second element in another embodiment. The terms of a singular form may include plural forms unless referred to the contrary.

Exemplary embodiments will be described below in more detail with reference to the accompanying drawings. A display surface, on which an image is displayed, is parallel to a surface which is defined by a first directional axis DR1 and a second directional axis DR2, and a normal direction of the display surface is indicated by a third directional axis DR3. The third directional axis DR3 is a reference axis distinguishing front and rear surfaces of each member. However, directions indicated by the directional axes are relative concepts and may thus be changed to other directions.

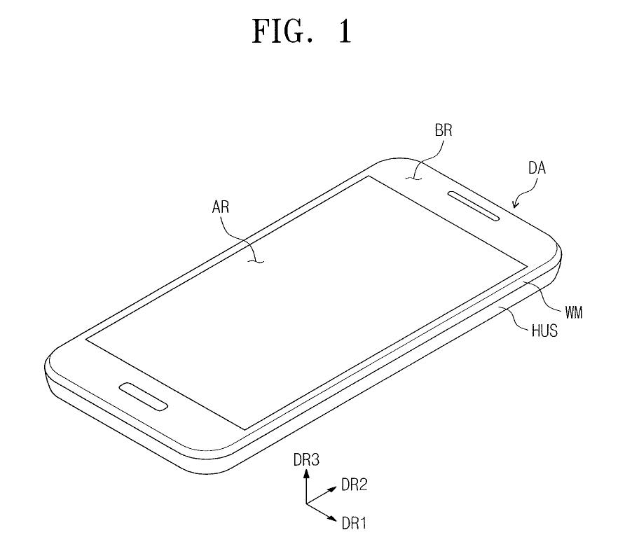

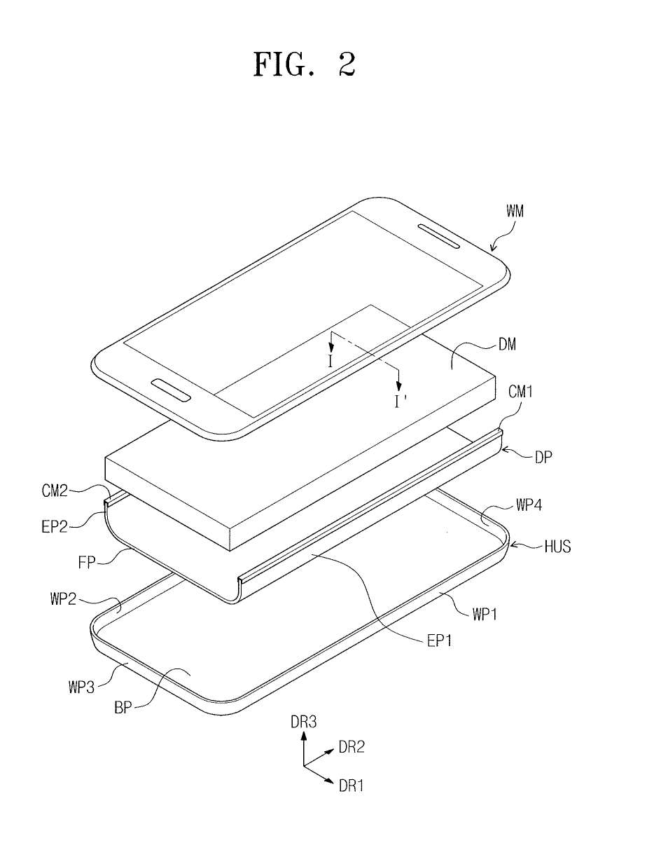

FIG. 1 is a perspective view illustrating a display apparatus according to an embodiment, and FIG. 2 is an exploded perspective view illustrating a display apparatus according to an embodiment.

In FIG. 1, a mobile phone is illustrated as an embodiment. However, the present disclosure is not limited thereto. Embodiments may be used not only for large electronic equipment, e.g., televisions or outdoor advertising panels, but also for small and medium electronic equipment, e.g., personal computers, laptops, personal digital terminals, car navigation units, game machines, portable electronic devices, wristwatch type electronic devices, and cameras. These are only presented as examples, and embodiments may be applied to other electronic devices.

As illustrated in FIG. 1, a display apparatus DA may include a display area AR on which an image is displayed and a bezel area BR adjacent to the display area AR. For instance, the display area AR may have a rectangular shape. The bezel area BR surrounds the display area AR. In other words, the bezel area BR constitutes a border of the display area AR.

Referring to FIGS. 1 and 2, the display apparatus DA may further include a window member WM, a display panel DP, a cover member, a dummy member DM, and a housing HUS.

The window member WM constitutes a display surface of the display apparatus DA and simultaneously constitutes a front surface of the display apparatus DA. The window member WM may include a transparent substrate, e.g., a glass substrate, a plastic substrate, etc.

In the current embodiment, the window member WM is illustrated to be a rectangular plate as an example. A planar shape of the window member WM may be modified according to a design of the display apparatus DA. For example, the window member WM may have, in a plane, a rectangular shape with rounded corners.

The window member WM has an opening corresponding to the display area AR. The window member WM has a shape overlapping the bezel area BR. The image generated in the display panel DP is supplied to the display area AR and through the opening of the window member WM to the outside.

The display panel DP is configured to display the image and is disposed to face a rear surface of the window member WM. The display panel DP includes a flat part FP and an edge part bent from the flat part FP.

The flat part FP of the display panel DP substantially overlaps the display area AR. The flat part FP is spaced apart from the window member WM by a predetermined distance. The flat part FP may have a rectangular shape defined with four sides.

The edge part of the display panel DP may be located at least at one side of the flat part FP. The edge part may be provided to correspond to one or more sides of the flat part FP.

As illustrated in FIG. 2, the edge part includes a first edge part EP1 extending from one side of the flat part FP, and a second edge part EP2 extending from the other side which faces the one side of the flat part FP in the first direction DR1. The first edge part EP1 and the second edge part EP2 are bent toward the window member WM with a predetermined curvature. Hereinafter, bending of the first and second edge parts EP1 and EP2 toward the window member WM is defined as inward bending. Bending toward a direction opposite to that of the inward bending is defined as outward bending.

In FIG. 2, it is illustrated that the first edge part EP1 and the second edge part EP2 are disposed at both sides of the flat part FP to be symmetrical with respect to the flat part FP, but embodiments are not limited thereto. For example, one or more edge parts may be provided, and when the edge part is provided in plurality, the plurality of edge parts may also be disposed to be adjacent to each other.

The cover member covers one end portion extending in the second direction DR2 of the first edge part EP1, and the other end portion extending in the second direction DR2 of the second edge part EP2. In detail, the cover member includes a first cover member CM1 covering an end portion of the first edge part EP1, and a second cover member CM2 covering an end portion of the second edge part EP2. The first cover member CM1 extends in the second direction DR2 along the end portion of the first edge part EP1, and the second cover member CM2 extends in the second direction DR2 along the end portion of the second edge part EP2.

The first cover member CM1 and the second cover member CM2 may have flexibility. The first cover member CM1 and the second cover member CM2 may be formed of, e.g., metal, rubber, etc. Also, the first cover member CM1 and the second cover member CM2 are provided as adhesive tapes and may cover an end portion of the display panel DP.

The dummy member DM is disposed between the display panel DP and the window member WM. The dummy member DM allows a, e.g., constant, distance between the display panel DP and the window member WM to be maintained. The dummy member DM is a transparent member and may include a plastic film. In a plane, the dummy member DM is disposed within the flat part FP and thus has the substantially same area as the display area AR. This is for the purpose of providing an identical light path between the display panel DP and the window member WM regardless of a region in the display area AR.

A pressure-sensitive adhesive layer may be respectively disposed between the dummy member DM and the window member WM and between the dummy member DM and the display panel DP. In an embodiment, the dummy member DM may be omitted. In an embodiment, the dummy member DM may be replaced with an optical member, e.g., a polarizing plate.

The dummy member DM may have a thickness greater than that of the display panel DP along the third direction DR3, but is not limited thereto. Thus, the dummy member DM may have a thickness smaller than that of the display panel DP within a range allowing the display panel DP to be protected.

The housing HUS accommodates the display panel DP and is coupled to the window member WM. The housing HUS includes a bottom part BP and a side wall part.

The bottom part BP corresponds to the flat part FP of the display panel DP, and is disposed on a rear surface of the display panel DP. The side wall part includes a first side wall part WP1 and a second side wall part WP2 which correspond to the first edge part EP1 and the second edge part EP2, respectively, and a third side wall part WP3 and a fourth side wall part WP4 which connect the first side wall part WP1 and the second side wall part WP2. The side wall parts WP1 through WP4 may be formed to be bent and extended from the bottom part BP.

The bottom part BP, the first side wall part WP1, and the second side wall part WP2 support the flat part FP, the first edge part EP1, and the second edge part EP2, respectively. The first wide wall part WP1 and the second side wall part WP2 may have substantially the same length as the first edge part EP1 and the second edge part EP2. The length is measured along the third direction DR3.

Unlike the display panel DP, the housing HUS has a rigid property. The housing HUS may be formed of, e.g., plastic or metal or the like. The bottom part BP, the first side wall part WP1, and the second side wall part WP2 have an integrated shape or may be parts which may be assembled to each other.

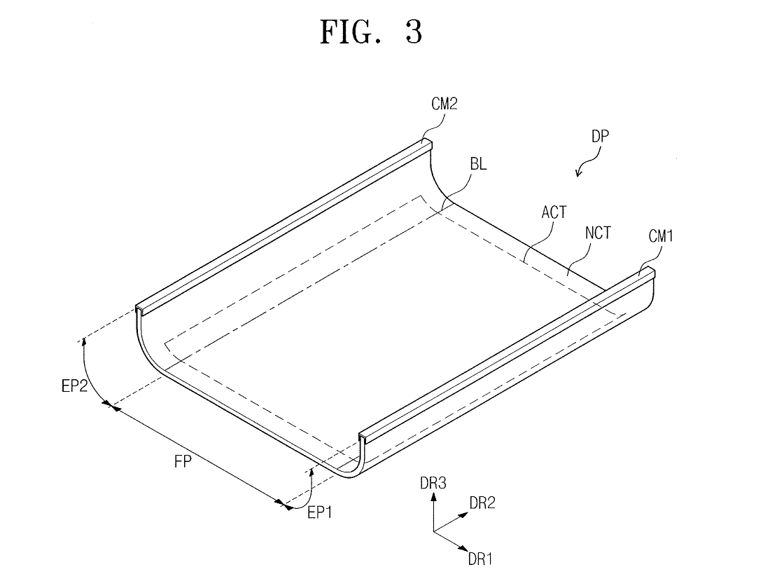

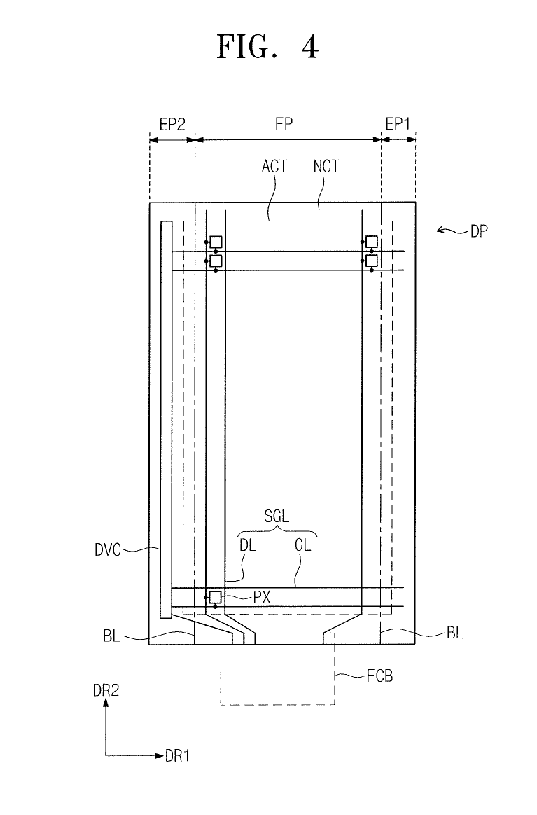

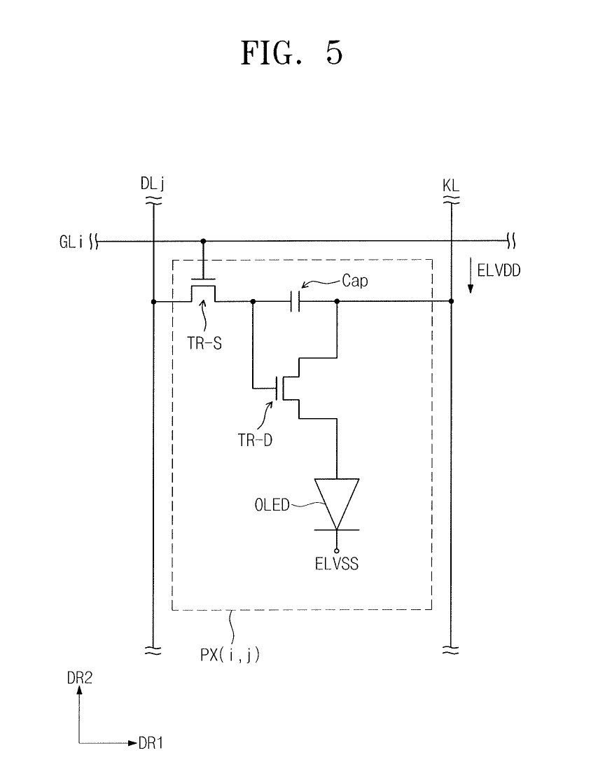

FIG. 3 is an enlarged perspective view illustrating the display panel DP, and FIG. 4 is a plan view illustrating the display panel DP in an unbent state. FIG. 5 is an equivalent circuit diagram of a pixel according to an embodiment. Hereinafter, the display panel DP will be described in more detail with reference to drawings.

Referring to FIG. 3, at least a portion of the display panel DP may have flexibility. When the first edge part EP1 and the second edge part EP2 are inwardly bent from the flat part FP along virtual folding lines BL, the folding lines are provided in the portion of the display panel DP having flexibility. In an embodiment, the first edge part EP1 and the second edge part EP2 may have flexibility. In an embodiment, the entire display panel DP may have flexibility.

The display panel may be, e.g., an organic light emitting diode display panel, a plasma display panel, a liquid crystal display panel, an electrowetting display panel, an electrophoretic display panel, a micro-electomechanical system (MEMS) display panel, and the like. In an embodiment, the organic light emitting diode display panel is described as an example.

The display panel DP is subdivided into the flat part FP, the first edge part EP1, and the second edge part EP2. Further, the display panel may also be subdivided into an active area ACT and an inactive area NCT according to whether a pixel PX is disposed or not. The active area ACT may be defined as an area on which the pixel PX is disposed, and the inactive area NCT may be defined as an area on which the pixel PX is not disposed. In the current embodiment, the inactive area NCT may be provided along a border of the active area ACT.

FIG. 3 illustrates that two folding lines BL overlap the active area ACT, but this is just an example. Thus, the two folding lines BL may also overlap the inactive area NCT. That is, in an embodiment, the pixel PX may not be disposed in the first edge part EP1 and the second edge part EP2.

As illustrated in FIG. 4, the display panel DP includes a plurality of signal lines SGL. The plurality of the signal lines SGL includes a plurality of scan lines GL and a plurality of data lines DL. A scan line GL and a data line DL are connected to a corresponding pixel PX among a plurality of pixels PX. At one side of the inactive area NCT, a drive circuit DVC connected to the scan lines GL may be disposed.

The display panel DP may be connected to a flexible circuit board FCB. The flexible circuit board FCB may be connected to the flat part FP. The flexible circuit board FCB may be connected to the data lines DL and the drive circuit DVC. The display panel DP and other circuit boards may be electrically connected through the flexible circuit board FCB.

FIG. 5 exemplarily illustrates a pixel PX (i, j) connected to an i-th scan line GLi among the scan lines GL and a j-th data line DLj among the data lines DL. The configuration of the pixel PX (i, j) is not limited thereto, and may thus be modified for another embodiment.

The pixel PX (I, j) includes an organic light emitting diode OLED as a display element. The pixel PX (I, j) may include, as a circuit part for driving the organic light emitting diode, a switching thin-film transistor TR-S, a driving thin-film transistor TR-D, and a capacitor Cap.

The switching thin-film transistor TR-S outputs a data signal applied to the j-th data line DLj in response to a scan signal applied to the i-th scan line GLi. The capacitor Cap charges a voltage corresponding to the data signal received from the switching thin-film transistor TR-S.

The driving thin-film transistor TR-D is connected to the organic light emitting diode OLED. The driving thin-film transistor TR-D controls a driving current flowing in the organic light emitting diode OLED according to an amount of electric charge stored in the capacitor Cap. The organic light emitting diode OLED emits light during a turn-on period of the driving thin-film transistor TR-D.

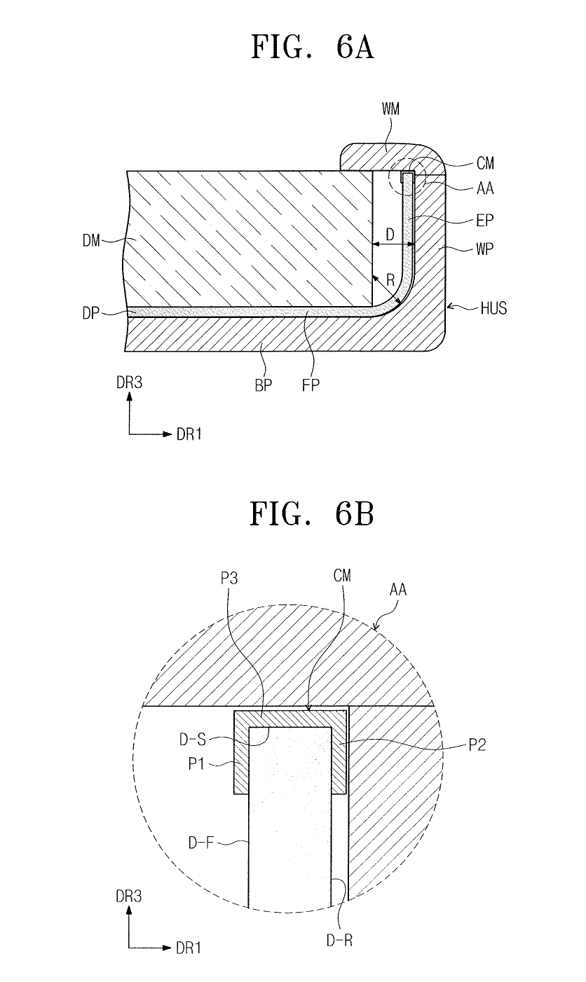

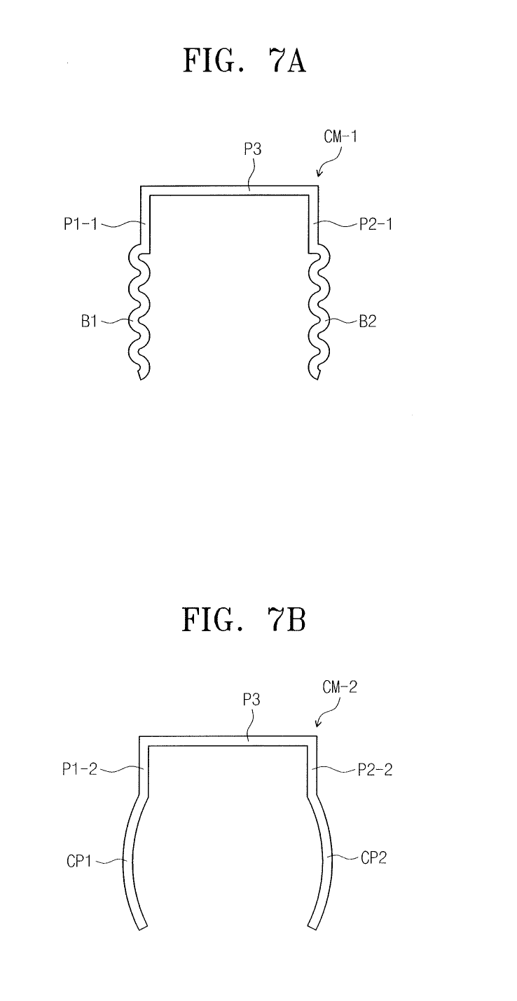

FIG. 6A is a cross-sectional view taken along line IT of FIG. 2 in an assembled state of the display apparatus, and FIG. 6B is an enlarged view illustrating a portion AA of FIG. 6A.

Referring to FIGS. 6A and 6B, the display panel DP includes a first front face D-F facing the dummy member DM, a first rear surface D-R facing the first front face D-F, and a connection surface connecting the first front surface D-F and the first rear surface D-R. For example, as illustrated in FIG. 6A, the connection surface may include surfaces of the first and second edge parts EP1 and EP2 facing the window member WM, e.g., surfaces of the first and second edge parts EP1 and EP2 that are parallel to a bottom of the bottom part BP of the housing HUS. In the current embodiment, the connection surface includes four side surfaces. Hereinafter, for convenience of description, one end surface of the edge part EP located at one side of the display panel DP among the four side surfaces will be referred to as a first side surface D-S.

From a cross-sectional view, at least a portion of the first edge part EP1 and the second edge part EP2 (hereinafter, edge part EP) is bent, and has a predetermined radius of curvature R. The radius of curvature R may vary according to the thickness and elasticity of the display panel DP, the size of the space, etc. A distance D from one side of the dummy member DM to the side wall part WP may be equal to or greater than the radius of curvature R.

The cover member CM covering one end portion of the edge part EP includes a first portion P1 facing the first front face D-F, a second portion P2 opposite to the first portion P1 and facing the first rear surface D-R, and a third portion P3 connecting the first portion P1 and the second portion P2.

The first portion P1 and the second portion P2 are disposed to be spaced apart from and parallel to each other. The third portion P3 is disposed perpendicular to the first portion P1 and the second portion P2. One end of the third portion P3 is connected to the first portion P1, and the other end of the third portion P3 is connected to the second portion P2. For example, as illustrated in FIG. 6B, the first through third portions P1 through P3 may be integral with each other, i.e., a seamless and single member, and completely cover surfaces of the first and second edge parts EP1 and EP2 facing the window member WM and portions adjacent thereto.

The third portion P3 is disposed to face the first side surface D-S. The first portion P1, the second portion P2, and the third portion P3 respectively contact the first front surface D-F, the first rear surface D-R, and the first side surface D-S, respectively.

The second portion P2 is disposed between the first rear surface D-R and the side wall part WP. The third portion P3 is disposed between the first side surface D-S and the window member WM.

The cover member CM may have a shape of an inverted “U” corresponding to the shape of one end portion of the edge part EP. However, the shape is not limited thereto, and the cover member CM may be provided in various shapes corresponding to the shape of one end portion of the edge part EP. As one end portion of the edge part EP is inserted into a space between the first portion P1 and the second portion P2, damage applied to the one end portion of the edge part EP may be reduced.

For example, in a display panel without the cover member CM, a crack may be generated at one end portion of a bent edge part while the display panel is being bent toward a front surface of the display panel, or a film on the one end portion of the edge part may be peeled off. However, as the display apparatus DA according to an embodiment includes the cover member CM protecting the one end portion of the edge part EP, a shock, a scratch, or the like applied from the outside, may be prevented when the edge part EP is bent. Accordingly, damage applied to the display panel DP may be reduced to enhance a displaying quality of the display panel DP and prevent a decrease in service life of the display panel DP. Also, the display apparatus DA according to an embodiment may have a minimize bezel width, as one or more sides of the display panel DP are bent.

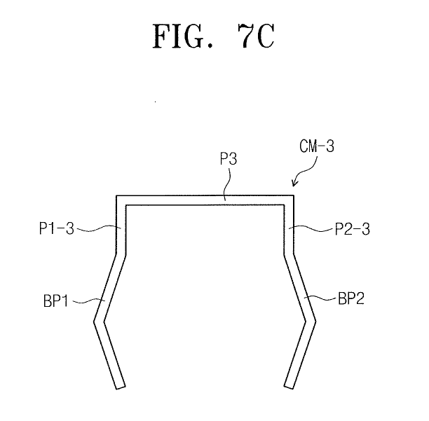

FIGS. 7A through 7C are cross-sectional views illustrating a cover member according to another embodiment. Hereinafter, the cover member according to the other embodiment will be described with reference to the accompanying drawings. For convenience of description, the same description as that of the cover member CM according to the previous embodiment will be omitted herein.

Referring to FIG. 7A, a cover member CM-1 includes a first portion P1-1, a second portion P2-1, and a third portion P3-1. The first portion P1-1 has a first concavo-convex portion B1 formed in at least a part of the first portion P1-1. The second portion P2-1 has a second concavo-convex portion B2 formed in at least a part of the second portion P2-1. The first and second concavo-convex portions B1 and B2 respectively face each other and are symmetrical to each other.

As the cover member CM-1 includes the first and second concavo-convex portions B1 and B2, a friction force between the cover member CM-1 and the display panel DP may be increased. Accordingly, the cover member CM-1 allows the display panel DP to be more firmly fixed to enhance the durability of the display panel DP.

Referring to FIG. 7B, the cover member CM-2 includes a first portion P1-2, a second portion P2-2, and a third portion P3. The first portion P1-2 has a first curved surface portion CP1 formed in at least a part of the first portion P1-2. The second portion P2-2 has a second curved surface portion CP2 formed in at least a part of the second portion P2-2. The first and second curved surface portions CP1 and CP2 respectively face each other and are symmetrical to each other. The distance between the first and second curved surface portions CP1 and CP2 is equal to or greater than the length of the third portion P3.

As the cover member CM-2 includes the first and second curved surface portions CP1 and CP2, an area where the first and second portions P1-2 and P2-2 contact front and rear surfaces of the display panel DP may be reduced. As the area where the cover member CM-2 pressurizes the display panel DP is reduced, damage to the front and rear surfaces of the display panel DP applied by the cover member CM-2 may be reduced.

Referring to FIG. 7C, the cover member CM-3 includes a first portion P1-3, a second portion P2-3, and a third portion P3. The first portion P1-3 has a first bent portion BP1 formed in at least a part of the first portion P1-3. The second portion P2-3 has a second bent portion BP2 formed in at least a part of the second portion P2-3. The first and second bent portions BP1 and BP2 respectively face each other and are symmetrical to each other. The distance between the first and second bent portions BP1 and BP2 is equal to or greater than the length of the third portion P3.

As the cover member CM-3 includes the first and second bent portions BP1 and BP2, an area where the first and second portions P1-3 and P2-3 contact front and rear surfaces of the display panel DP may be reduced. As an area where the cover member CM-3 pressurizes the display panel DP is reduced, damage to the front and rear surfaces of the display panel DP applied by the cover member CM-3 may be reduced.

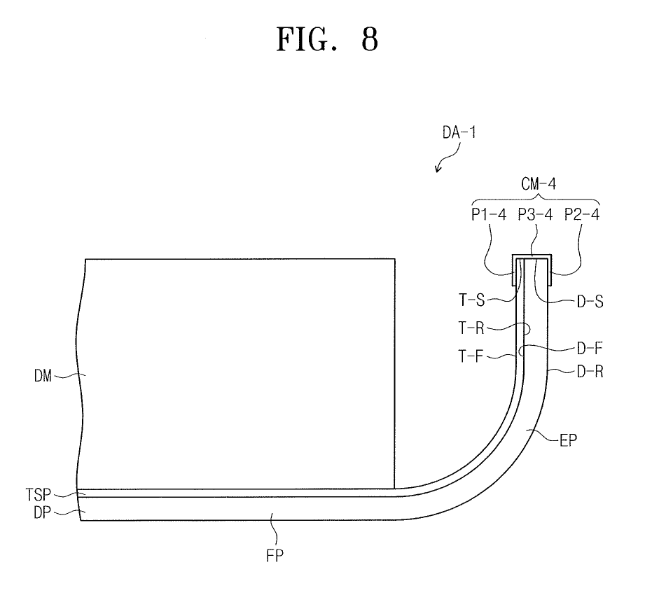

FIG. 8 is a cross-sectional view illustrating one component of a display apparatus according to another embodiment. For convenience of description, the same description as that described in the previous embodiment will be omitted herein.

Referring to FIG. 8, a display apparatus DA-1 according to another embodiment may include the display panel DP, the dummy member DM, a cover member CM-4, and a touch sensor TSP detecting a touch event of a user. The touch sensor TSP may be disposed on the first front surface D-F of the display panel DP. As a result, the touch sensor TSP may be disposed between the display panel DP and the dummy member DM.

In the current embodiment, when viewed from the top, the touch sensor TSP is formed to have the same area and shape as those of the display panel DP, and thus the touch sensor TSP may be provided on entire surfaces of the flat part FP and the edge part EP of the display panel DP. The touch sensor TSP is bent together with the display panel DP.

The touch sensor TSP includes a second front surface T-F, a second rear surface T-R facing the second front surface T-F, and a connection surface connecting the second front surface T-F and the second rear surface T-R. In another embodiment, the connection surface includes four side surfaces. Hereinafter, for convenience of description, one end surface of the portion which is bent at one side of the touch sensor TSP among the four side surfaces is referred to as a second side surface T-S.

The dummy member DM is disposed on the second front surface T-F. The second rear surface T-R contacts the first front surface D-F. The second side surface T-S is coplanar with a first side surface D-S of the display panel DP.

The cover member CM-4 may cover one end portion of the edge part EP, and one end portion of the touch sensor TSP adjacent to the one end portion of the edge part EP. The cover member CM-4 includes a first portion P1-4 facing the second front face T-F, a second portion P2-4 opposite to the first portion P1-4 and facing the first rear surface D-R of the display panel DP, and a third portion P3-4 connecting the first portion P1-4 and the second portion P2-4. The third portion P3-4 is disposed to face the first side surface D-S and the second side surface T-S.

The first and second portions P1-4 and P2-4 respectively contact the front surface T-F and the first rear surface D-R. The third portion P3-4 contacts the first side surface D-S and the second side surface T-S.

The cover member CM-4 may simultaneously cover and protect the one end portion of the edge part EP and the one end portion of the touch sensor TSP, and allow the display panel DP and the touch sensor TSP to be fixed to each other.

The cover member CM-4 may prevent phenomena that a crack is generated or a film is peeled off at the one end portion of the edge part EP and the one end portion of the touch sensor TSP when the display panel DP and the touch sensor TSP are bent. Also, the cover member CM-4 prevents the phenomenon that the display panel DP and the touch sensor TSP are separated from each other when they are bent, and thus durability of the display panel DP may be enhanced.

In the present embodiment, it is illustrated in the drawings that the cover member CM-4 covers the one end portions of the display panel DP and the touch sensor TSP, but embodiments are not limited thereto. When one or more optical members are disposed on a front surface or a rear surface of the display panel DP and are bent together with the display panel DP, the cover member may simultaneously cover end portions of the display panel DP and the optical members.

By way of summation and review, a display apparatus according to an embodiment prevents damage to an edge part when the edge part is bent, and thus a defect of a display panel can be prevented. Also, as one or more sides of the display panel DP are bent, the width of the bezel may be minimized.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A display apparatus, comprising:
a display panel to display an image, the display panel including a flat part and an edge part at least at one side of the flat part and bent toward a direction in which the image is displayed; and
a cover member surrounding an end portion of the edge part.

2. The display apparatus as claimed in claim 1, wherein the display panel includes:
a first front surface to display the image;
a first rear surface facing the first front surface; and
a first side surface connecting the first front surface and the first rear surface.

3. The display apparatus as claimed in claim 2, wherein the cover member includes:
a first portion facing the first front surface;
a second portion opposite the first portion and facing the first rear surface; and
a third portion connecting the first portion and the second portion and facing the first side surface.

4. The display apparatus as claimed in claim 3, wherein the cover member further comprises a first concave-convex part on at least a part of the first portion, and a second concave-convex part facing the first concave-convex part and on at least a part of the second portion.

5. The display apparatus as claimed in claim 3, wherein the flat part has a rectangular shape defined with four sides.

6. The display apparatus as claimed in claim 5, wherein the edge part corresponds to at least one of the four sides of the flat part.

7. The display apparatus as claimed in claim 6, wherein the cover member extends in a direction in which at least one of the four sides of the flat part extends, along the end portion of the edge part.

8. The display apparatus as claimed in claim 2, further comprising a touch sensor on the first front surface to detect a touch event of a user.

9. The display apparatus as claimed in claim 8, wherein the touch sensor includes a second rear surface facing the first front surface, a second front surface facing the second rear surface, and a second side surface connecting the second front surface and the second rear surface.

10. The display apparatus as claimed in claim 9, wherein the cover member includes:
a first portion facing the second front surface;
a second portion opposite to the first portion and facing the first rear surface; and
a third portion connecting the first portion and the second portion, and facing the first side surface and the second side surface.

11. The display apparatus as claimed in claim 2, further comprising a housing accommodating the display panel, the housing including:
a bottom part facing the first rear surface of the display panel and parallel to the flat part; and
a side wall part bent from the bottom part toward the direction in which the image is displayed.

12. The display apparatus as claimed in claim 11, further comprising a window member on the display panel and coupled to the housing.

13. The display apparatus as claimed in claim 12, further comprising a dummy member between the display panel and the window member.

14. The display apparatus as claimed in claim 1, wherein the cover member includes a flexible metal, rubber, or an adhesive tape.

15. The display apparatus as claimed in claim 1, wherein the edge part is at least partially bent to have a predetermined radius of curvature.
